(19) United States
(12) Patent Application Publication
(10) Pub. No.: US 2008/0015478 A1
(43) Pub. Date: Jan. 17, 2008

(54) COUNTER PULSATION SYSTEM AND METHOD FOR STROKE RECOVERY TREATMENT

(76) Inventor: Arani Bose, New York, NY (US)

Correspondence Address: STALLMAN & POLLOCK LLP, 353 SACRAMENTO STREET, SUITE 2200, SAN FRANCISCO, CA, 94111, US

(21) Appl. No.: 11/779,221

(22) Filed: Jul. 17, 2007

Related U.S. Application Data
(60) Provisional application No. 60/831,287, filed on Jul. 17, 2006.

(51) Int. Cl. A61H 15/00

(52) U.S. Cl. 601/152; 606/202

(57) ABSTRACT

A counterpulsation system for enhancing blood flow in a patient includes inflatable cuffs positionable on a leg of a patient. Three cuffs are preferably used for positioning on the calf, thigh, and buttocks. The cuffs are inflated in accordance with a timing sequence during diastole to enhance cerebral blood flow, and are then deflated. The process is repeated several times throughout a treatment session. A blood velocity sensor such as a transcranial Doppler (TCD) system detects cerebral blood flow velocity during treatment. The TCD output produces a first peak P1 corresponding to the blood flow velocity during a contraction of the heart and a second peak P2 corresponding to blood flow velocity resulting from the compression forces of the cuffs. If P2 does not exceed P1, the timing sequence is manually or automatically altered to optimize the effect of the compression sequence during diastole.

### PRIORITY CLAIM

This application claims the benefit of U.S. Provisional Application Ser. No. 60/831,287, filed Jul. 17, 2006.

### TECHNICAL FIELD OF THE INVENTION

The present invention relates to the field of systems for increasing blood flow to the brain during a period following a stroke.

### BACKGROUND

Enhanced External Counterpulsation (EECP) is a method employed to non-invasively increase blood flow to ischemic regions of the heart in patients suffering from angina. EECP treatments employ a series of inflatable compressive cuffs wrapped around the patient's calves, thighs, and buttocks. During diastole when the heart is at rest, the cuffs are inflated sequentially from the calves proximally. The cuffs are simultaneously deflated at the onset of atrial systole. The system increases blood flow to the heart, increasing the amount of oxygen delivered to the heart tissue. The EECP system is responsive to ECG signals, which trigger inflation and deflation of the cuffs based on events in the cardiac cycle.

When a patient has suffered a stroke, it can be beneficial to increase the flow of blood to the brain so as to bring more oxygen to tissue of the brain affected by the stroke, thereby expediting recovery of the patient. The present application relates to the use of EECP to increase blood flow to the brain.

### BRIEF DESCRIPTION OF THE DRAWINGS

FIG. 1 is a diagram illustrating a series of counterpulsation cuffs on a leg of a patient.

FIG. 2 a block diagram schematically illustrating one embodiment of a counterpulsation system for stroke therapy.

FIG. 3 shows an EKG waveform and illustrates a triggering sequence for the system of FIG. 2.

FIG. 4A shows a Transcranial Doppler (TCD) waveform. FIG. 4B shows a TCD waveform during counterpulsation.

### DETAILED DESCRIPTION

A counterpulsation system according to the disclosed embodiment is adapted for use in increasing blood flow to the brain. By driving blood from the legs to the heart during diastole, the system increases the volume of blood pumped by the heart during systole and thereby increases the amount of blood delivered to the brain. This is accomplished using a sequence of cuffs activated in a manner similar to EECP systems to increase the amount of blood returning to the heart via the venous system. Feedback, which may take the form of Transcranial Doppler, is employed to ensure that the timing sequence used for the cuffs is increasing cerebral blood flow.

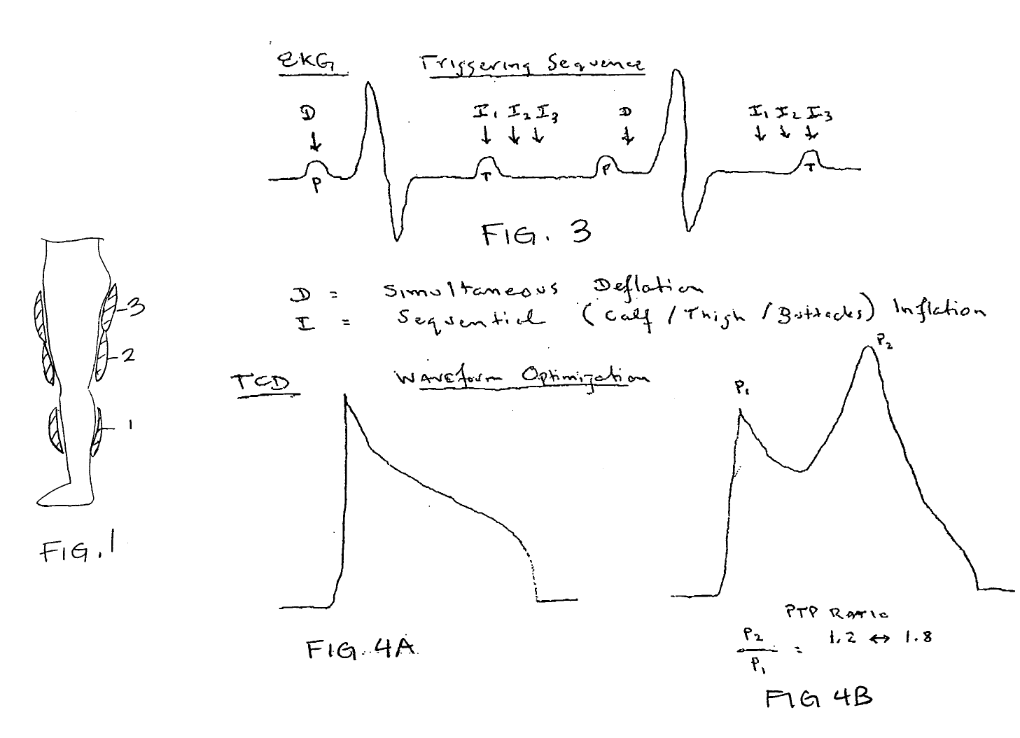

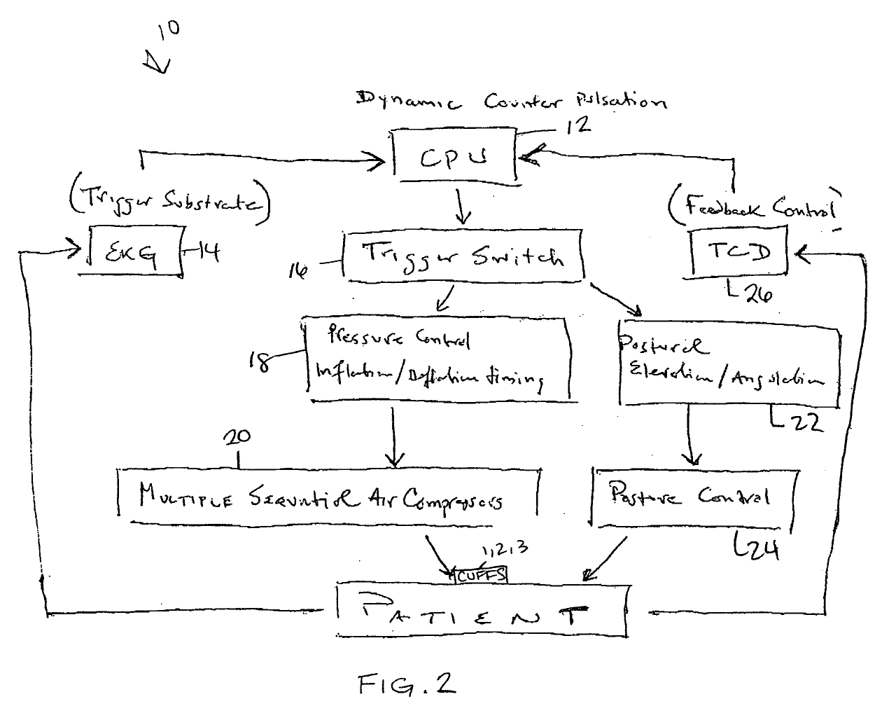

FIG. 1 is a side view of a human leg showing counterpulsation cuffs 1, 2, 3 at spaced locations on the leg (e.g. calf, thigh and upper thigh and/or buttocks). As shown in FIG. 2, a counterpulsation system 10 includes a CPU 12 that governs inflation and deflation of the cuffs 1, 2, 3. In particular, CPU 12 is responsive to signals from an EKG system 14 to activate a trigger switch 16 that triggers inflation/deflation timing circuitry 18 for the cuffs 1, 2, 3. Actuators 20 for the cuffs are responsive to signals from the inflation/deflation timing circuitry 18 to cause the compression cuffs to impart and to release compressive forces on the leg. In a preferred form of the invention, the cuffs 1, 2, 3 are inflatable cuffs and actuators 20 are air compressors fluidly coupled to the cuffs 1, 2, 3 to inflate and deflate the cuffs.

According to one method of using the system, trigger switch 16 may be activated upon detection of the “T” wave (representing ventricular diastole), at which time timing circuitry 18 will cause air compressors 20 associated with each of the cuffs 1, 2, 3 to sequentially inflate the cuffs at calculated timing intervals within diastole, as indicated by I1, I2 and I3 in FIG. 3. In alternate embodiments, trigger switch 16 may instead be activated upon detection of another point in the cardiac cycle. An alternate timing for the trigger switch 16 might be used, for example, if it is determined in response to blood flow monitoring (such as the TCD testing described below) that earlier/later activation of the cuffs will place the compression sequence at an optimal time during diastole, or to compensate for a delay between activation of trigger switch 16 and inflation of the cuff.

Deflation of the cuffs is preferably performed simultaneously upon detection of the P wave (representing contraction of the atria) as indicated by D in FIG. 3. The sequence of inflating/deflating the cuffs is repeated over the course of a treatment period, which may be on the order of one or more hours per day for several days or weeks. Counter pulsation may be combined with periodic movement of the patient in and out of a trendelenburg (head-down) position to further enhance cerebral perfusion. Thus, as illustrated in FIG. 2, trigger switch 16 may additionally govern a postural elevation system 22 that activates a positioning system 24 on the table supporting the patient.

The system 10 preferably comes with means for ensuring that the desired increase in brain perfusion is being accomplished. In particular, a Transcranial Doppler (“TCD”) system 26 may be used to generate waveforms representing the velocity of blood moving through the cerebral arteries, the internal carotid arteries, or the basilar or vertebral arteries. Blood flow charteristics in these arteries can be sampled by positioning the ultrasound transducer location to detect blood flow through the orbit of the eye, or through other access locations in the temporal and suboccipital regions of the cranium. Other embodiments might employ alternative techniques for monitoring blood flow velocity.

FIG. 4A illustrates a TCD waveform representing normal blood velocity through cerebral vasculature over time. The peak of the waveform represents the increase in blood velocity into the brain when the heart contracts. FIG. 4B illustrates a TCD waveform representing blood velocity during counterpulsation. As shown, contraction of the cuffs forces additional blood into the brain, thus creating a second spike in the blood velocity into the brain. In FIG. 4B, the first peak, P1, represents the increase in blood velocity during contraction of the heart, whereas the second peak P2 represents the increase in blood velocity during counterpulsation. As shown in FIG. 4B, the timing and magnitude of the waveform P2 effectively extends the duration of the blood flow within diastole and increases the velocity of the blood flow during the extended duration.

During use of the system, the TCD waveform is automatically or manually monitored for the presence of a second peak of a desired amplitude to ensure that the counterpulsation is having a desired effect on cerebral perfusion. If the desired effect is not achieved, the timing sequence for cuff inflation/deflation will be automatically or manually adjusted until the desired effect is achieved. In one embodiment, a desired effect is one in which the ratio (P2/P1) of the peak blood velocity P2 resulting from the counterpulsation exceeds the normal peak blood velocity P1 by a ratio of between 1.2 and 1.8.

Elements of the timing sequence may include (1) the time relative to the cardiac cycle (e.g. relative to the T-wave or P-wave) at which the compression sequence is initiated; (2) the time intervals between activation of cuffs 1 and 2, 2 and 3 or 1 and 3; (3) the inflation force or target inflation pressure for the cuffs; (4) the rate of inflation of the cuffs, or the time it takes to inflate a cuff to the target inflation pressure; (5) the time relative to the cardiac cycle at which each or all of the cuffs is deflated.

When the timing sequence is adjusted in response to feedback from the TCD system, any one or any combination of these elements may be adjusted. For example, initiation of the compression sequence relative to the EKG waveform might be shifted such that it occurs prior to the T-wave, as shown on the right hand side of the FIG. 3 waveform. As another example, the intervals of time that pass between initiating inflation of cuff 1 and initiating inflation of cuffs 2 and 3 might be shortened or lengthened. The target inflation force, pressure, rate etc. might be increased or decreased. The timing of deflation of the cuffs relative to the cardiac cycle (e.g. P-wave) might be increased or decreased, or the time delay between initiating/completing inflation of any or all of the cuffs and deflating the cuffs might be increased or decreased.

In an exemplary method using the system, the cuffs 1, 2, 3 are positioned on the calf, thigh and buttocks of the patient as shown in FIG. 1. The patient electrocardiogram is monitored using EKG 14, and an ultrasound transducer is positioned to monitor cerebral blood flow using TCD system 26. Upon detection of a T-wave by the EKG, the CPU 12 initiates sequential activation of air compressors 20 according to a predetermined timing sequence to inflate the cuffs 1, 2, 3. The controller then causes deflation of the cuffs (e.g. at a predetermined point in the cardiac cycle or following a predetermined interval of time). The TCD output is analyzed (by the controller or by the user) to identify a first peak P1 in the cerebral blood flow velocity corresponding to a contraction of the heart, and to identify a second peak P2 corresponding to the surge in cerebral blood flow caused by inflation of the cuffs. If the second peak does not meet desired criteria (e.g. P2>P1; or P2/P1 being between 1.2 and 1.8), then the timing sequence is altered and the compression sequence is repeated using the altered compression sequence. Depending on the adjustment made to the timing sequence, the subsequent compression sequences may or may not be triggered by detection of the T-wave.

The TCD output is preferably continuously monitored so that any additional changes can be made to the timing sequence.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the claims and their equivalents.

Any and all patents, patent applications and printed publications referred to above, including those relied upon for purposes of priority, are incorporated herein by reference.

I claim:

1. A method for applying counterpulsation to a patient, the method comprising:
(a) monitoring velocity of blood flowing through a blood vessel of a patient;
(b) positioning first and second compression devices on a limb of the patient;
(c) sequentially activating the first and second compression devices according to a timing sequence to impart compression forces to the limb;
(d) identifying a first peak in monitored blood flow velocity, said first peak corresponding to a contraction of the heart;
(e) identifying a second peak in monitored blood flow velocity;
(f) releasing the compression forces imparted in (c); and
(g) if the blood flow velocity of the first peak exceeds the blood flow velocity of the second peak, repeating (a) through (f) using an altered timing sequence.

2. The method according to claim 1, wherein if a ratio of the blood flow velocity of the second peak to the blood flow velocity of the first peak is within the range of approximately 1.2 to 1.8, repeating (a) through (e) without altering the timing sequence.

3. The method according to claim 1, wherein monitoring blood flow velocity includes positioning an ultrasound transducer to detect blood flow velocity in the blood vessel.

4. The method according to claim 3, including positioning the ultrasound transducer to detect blood flow through the orbit of the patient's eye.

5. The method according to claim 3, including positioning the ultrasound transducer to detect blood flow through a temporal region of the patient's cranium.

6. The method according to claim 3, including positioning the ultrasound transducer to detect blood flow through an occipital region of the patient's cranium.

7. The method according to claim 1, further including detecting ventricular diastole, and activating the compression devices upon detection of ventricular diastole.

8. The method according to claim 7, wherein detecting ventricular diastole includes monitoring an electrocardiogram to detect a T-wave.

9. The method according to claim 1, further including detecting contraction of the atria, and releasing the compression forces upon detecting contraction of the atria.

10. The method according to claim 9, wherein detecting contraction of the atria includes monitoring an electrocardiogram to detect a P-wave.

11. The method according to claim 1, further including moving the patient to a trendelenburg position during activation of the compression devices.

12. The method according to claim 1, wherein the method includes positioning first, second and third compression devices on the limb, and activating the first and second and third compression devices according to the timing sequence.

13. The method according to claim 1, wherein the second peak in monitored blood flow velocity corresponds to an increase in blood flow velocity resulting from the compression forces.

14. A counterpulsation system for enhancing blood flow in a patient, the system comprising;
at least two inflatable cuffs positionable on a limb of a patient;
a blood velocity sensor positionable to detect blood flow velocity in a blood vessel of the patient;
an electrocardiogram sensor positionable to detect an electrocardiogram;
a pump fluidly coupled to the inflatable cuffs; and
a controller in communication with the pump to control inflation and deflation of the cuffs in accordance with a timing sequence, the controller responsive to feedback from the blood velocity sensor to alter the timing sequence.

15. The counterpulsation system of claim 14, wherein the controller is operable to compare a first peak in monitored blood flow velocity corresponding to a contraction of the heart to a second peak in monitored blood flow velocity corresponding to an increase in blood flow velocity resulting from the compression forces, and to alter the timing sequence if the blood flow velocity of the first peak exceeds the blood flow velocity of the second peak.

16. The counterpulsation system of claim 15, wherein the controller is operable to alter the timing sequence if a ratio of the blood flow velocity of the second peak to the blood flow velocity of the first peak is within the range of approximately 1.2 to 1.8.

17. The counterpulsation system of claim 14, wherein the blood velocity is a Doppler sensor.

18. The counterpulsation system of claim 17, wherein the Doppler sensor is a transcranial Doppler sensor.

19. The counterpulsation system of claim 14, wherein the controller is responsive to signals from the electrocardiogram to cause inflation of the cuffs.

20. The counterpulsation system of claim 14, wherein the controller is responsive to signals from the electrocardiogram to cause deflation of the cuffs.
